(19) United States
(12) Patent Application Publication
(10) Pub. No.: US 2024/0139882 A1
(43) Pub. Date: May 2, 2024

(54) Laser Beam Shaping and Patterning for Manufacturing

(71) Applicant: Seurat Technologies, Inc., Wilmington, MA (US)

(72) Inventors: Selim Elhadj, Lexington, MA (US); Andrew J. Bayramian, Merblehead, MA (US); James A. DeMuth, Woburn, MA (US)

(21) Appl. No.: 18/495,223

(22) Filed: Oct. 26, 2023

Related U.S. Application Data
(60) Provisional application No. 63/419,875, filed on Oct. 27, 2022.

(51) Int. Cl. B23K 26/362

(52) U.S. Cl. CPC B23K 26/362; B23K 2101/34

(57) ABSTRACT

A laser manufacturing system includes a laser patterning unit having an optically addressed light valve and an image relay able to direct a patterned laser beam from the laser patterning unit against a part. In some embodiments the patterned laser beam can ablatively remove material from the part or induce selected chemical reactions or transformation in part material.

### RELATED APPLICATION

The present disclosure is part of a non-provisional patent application claiming the priority benefit of U.S. Patent Application No. 63/419,875, filed on Oct. 27, 2022, which is incorporated by reference in its entirety.

### TECHNICAL FIELD

The present disclosure generally relates to a system and method for high power laser processing of materials. In one embodiment, manufacturing is supported by a two-dimensional laser patterning unit having an optically addressed light valve that can provide a two-dimensional patterned laser beam that can ablatively remove material from the part or selectively induce patterned chemical reactions in part material.

### BACKGROUND

Micro-electronics are key components in automotive, industrial, medical, telecommunications, storage device, and consumer electronics industries. Manufacture of micro-electronics typically requires precise spatial control to assemble semiconductor, insulator, and conductor materials that can be integrated together with micro-electronics components such as small-scale transistors, capacitors, inductors, resistors, diodes along with insulators and conductors.

A conventional way to provide integrated assemblies relies on lithography. Lithographic processing uses expensive photomasks to pattern light exposure with a resist, producing and connecting complex patterns on work surfaces made up of epitaxially grown multilayer structures such as semiconductor p-n junction diodes. Etching and physical vapor deposition processes complement the process to discretize micro-electronic component on the surface of a wafer for example and provide electrification paths.

Processes and equipment that can integrate or replace multiple patterning, connection, or material processing steps using patterned laser beam shaping systems in controlled environments are needed to reduce cost and increase manufacturing throughput.

### SUMMARY

In some embodiments, a laser manufacturing system can include a laser patterning unit having an optically addressed light valve. An image relay can be situated and able to direct a patterned laser beam from the laser patterning unit against a part, with the patterned laser beam ablatively removing material from the part during operation.

In some embodiments, the part has multiple material layers, with selected layers being removable.

In some embodiments, the patterned laser beam can further induce selected chemical reactions in part material.

In some embodiments, the patterned laser beam can further laser peen part material.

In some embodiments, the laser patterning unit provides one-dimensional patterning.

In some embodiments, the laser patterning unit provides two-dimensional patterning.

In another embodiment, a laser manufacturing system, includes a laser patterning unit having an optically addressed light valve. An image relay is situated and able to direct a patterned laser beam from the laser patterning unit against a part, with the patterned laser beam arranged to induce selected chemical reactions or transformation in part material.

In some embodiments, the patterned laser beam can further ablatively remove material from the part.

In another embodiment, a laser manufacturing method includes the steps of providing a laser patterning unit having an optically addressed light valve. A patterned laser beam from the laser patterning unit is directed against a part using an image relay, with the patterned laser beam acting to at least one of inducing selected chemical reactions and ablatively removing material from the part using the patterned laser beam.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 illustrates an embodiment of a system having a laser-based shaped beam for control of ablative and reactive areas on a work surface;

FIG. 2A illustrates a programmable mask, laser-based shaped beam ablative system;

FIG. 2B illustrates a programmable mask, laser-based shaped beam system that enables spatially controlling reaction(s), chemistry, or other processing of a work surface;

FIG. 3 illustrates another embodiment of a laser processing system able to direct one or two dimensional light beams toward a part;

FIG. 4 illustrates a method of operating laser manufacturing system able to provide one or two dimensional light beams; and

FIG. 5 illustrates a laser manufacturing system that includes a switchyard system enabling reuse of patterned two-dimensional energy.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

A laser manufacturing system suitable for microelectronics manufacture, precision tool manufacture, or materials processing should be able to efficiently process a wide range of materials with high throughput. For example, systems that can provide arbitrarily shaped laser energy, or other forms of directed energy, to drive spatially controlled materials transformation localized within the shape of the footprint of the energy delivered to a work surface can be used. In some embodiments patterning can be achieved by moving a laser beam on a surface. Patterning can be provided using an optically addressable light valve that enables dynamic, programmable laser beam shaping. In some embodiments, laser peening, ablation, or cutting using subtractive manufacture techniques is possible. Laser processing can be used to induce to changes in crystal structure, influence stress patterns, or otherwise make chemically or physical modifications to form structures with desired properties.

In other embodiments useful in microelectronics manufacture, such laser manufacturing systems can enable use of localized ablation, with an insulating native layer being removed to expose an underlying conductive substrate for the purposes of providing direct access for electrical contact. In other applications (typically below that required for ablation) the laser beam energy can drive chemical reactions that can transform material at a work surface by formation of new compound materials using reactive species in a surrounding medium. As a result of these reactions, the electronic properties can be locally defined or patterned on the surface of the work piece to produce interconnected functional micro-electronics elements. The steps of etching and surface material transformation can be contained in a single laser processing system within an interchangeable reactive or inert medium.

In some embodiments a patterned laser beam can be shaped to provide pattern heating of a part or workpiece, and in some embodiments, reactively or thermally controlled surfaces or interfaces electrical properties by a subtractive (e.g. ablation) or additive process (by adding the compounding element from a surrounding environment (e.g. oxygen (O) from air to oxidize a material like a metal (M) to form a metal oxide (MOX) semiconductor or insulator). Compound surface materials can also be produced from a single material reacted by driving the thermally activated oxidation (Oxygen), nitration (Nitrogen), formation of carbide (Carbon) or other element for compound formation provided from a surrounding gaseous atmosphere, transparent liquid, or transparent solid in proximity to the processed surface or interface. Alternatively, or in addition, control of insulating, metallic, or semiconducting surface properties can be achieved by ablating off native (or grown) insulating layer (ex. a metal oxide) and exposing the underlying conductive metal using patterned laser energy exposure and absorption.

In some embodiments, exposure to a uniform shaped beam intensity enables a uniform interface temperature that supports uniform control of an interface reactive process and formation of a uniform layer (as opposed to, for example, to a typical Gaussian beam with non-uniform intensity and heating that produces non-uniform reactive field and non-uniform material layers with non-uniform electrical properties and composition)

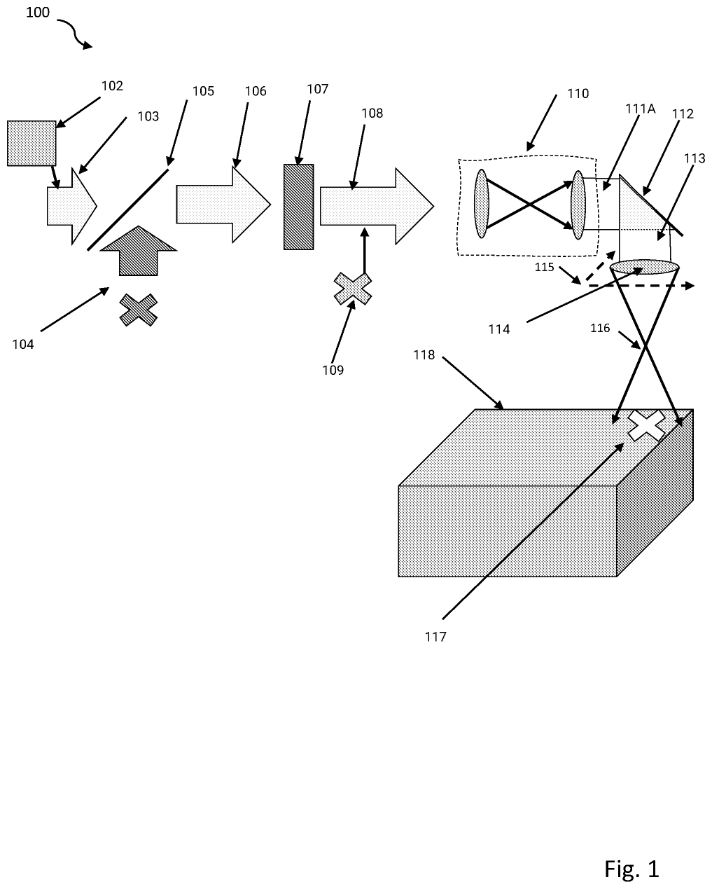

FIG. 1 illustrates an embodiment of a system 100 having a laser-based shaped beam for control of ablative and reactive areas on a work surface and that uses a programmable mask. The system can include a process laser read beam 102 at a first wavelength. The beam can be passed through a homogenizer (not shown) to convert a gaussian shaped beam into an evenly distributed laser read beam 103 at the first wavelength. The system 100 also supports an example write beam 104 with optional patterning (i.e. an X shape in FIG. 1) at a second wavelength. Each of the homogenized process laser read beam 103 and the write beam 104 can be directed at a dichroic beam combiner 105. The dichroic beam combiner 105 selectively reflects one of the first or second wavelengths and transmits the other of the first or second wavelength in order to combine the homogenized processed laser read beam 103 and the write beam 104 to generate a combined read and write beam 106. The combined read and write beam 106 is passed through an optically addressed light valve (OALV) 107. The OALV 107 can be a transmissive or reflective pixel addressable light valve. In one embodiment, the pixel addressable light valve includes both a liquid crystal module having a polarizing element and a light projection unit providing a two-dimensional input pattern that can separate the beam by splitting a light source into negative and positive patterned images. The combined read and write beam 106 is passed through the OALV 107, which then spatially imprints a pattern in polarization space on the drive beam. The polarization state of the light desired is allowed to continue to the rest of the optical system, and the unwanted state is rejected and thrown away to a beam dump or other energy rejection device. The patterned part of the beam is transmitted as transmitted process laser beam 108. Transmitted process laser beam 108 can include an image 109 provided from the OALV 107. Process laser beam 108 can pass through a series of image relay optics 110 before the output transmitted process laser beam 111 hits a positioning mirror 112. An output beam 113 from the positioning mirror 112 passes through an imaging lens 114. The optical system can be movable in, for example, XY directions as shown by arrow 115. In one embodiment a final imaging beam 116 can be directed to intersect a work surface 118 (which can be a structure or other material) at position 117 where it subtractively processes, induces chemical reactions, or ablates a portion of a surface material (e.g. causing removal of oxides and creating an exposed conductive patch). In one embodiment, for example, a substrate material may be ablated to remove aluminum oxide and leave a conductive area of aluminum. In an example implementation, the imaging beam 116 may be a ultra-short pulse beam (e.g. picosecond). In this example a thin layer of oxide can be removed without damaging the underlying substrate.

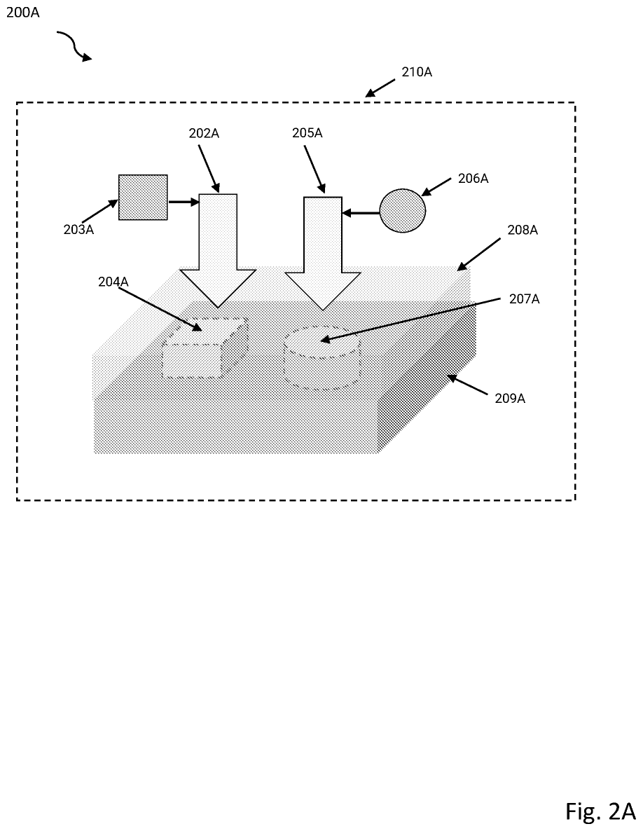

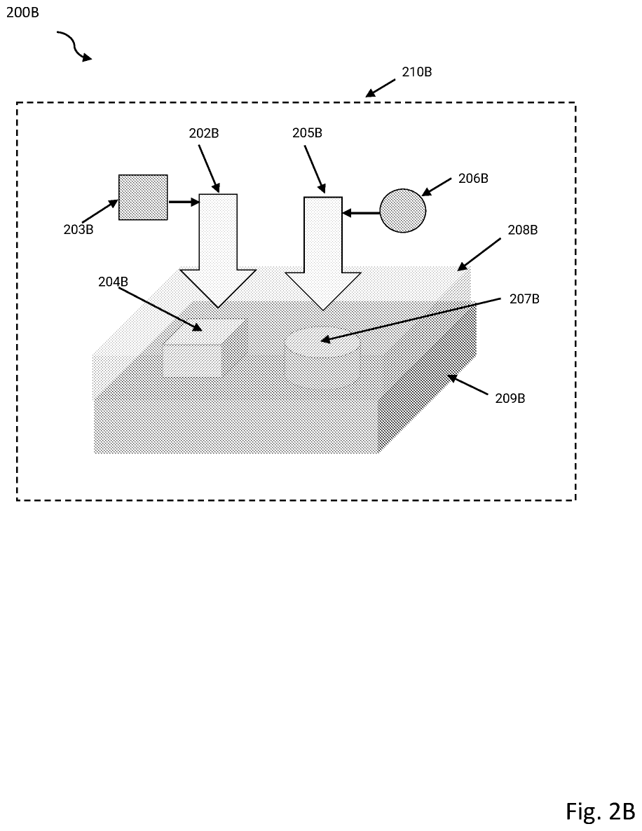

FIG. 2A illustrates a programmable mask, laser-based shaped beam ablative system 200A that enables processing of a work surface that can be positioned in an optional chamber or ambient controlled volume 210A. In one example, ablative processing may be executed using the system described in FIG. 1. In one embodiment, a shaped process laser beam 202A (corresponding to imaging beam 116 of FIG. 1) is patterned using a programmable mask (corresponding to OALV 107 of FIG. 1). The process laser beam 202A may be patterned with a rectangular pattern 203A. As a result, a rectangular shaped ablation pattern 204A is created. In a second example the process laser beam 205A may be patterned with a circular pattern 206A. As a result, a circular shaped ablation pattern 207A is created. The pattern may be created in an insulation layer 208A that can be, for example, a metal oxide positioned on a substrate 209A. The described ablation technique may be used to create accessible conductive contact points on a semi-conductor wafer. Although the rectangular shaped ablation pattern 204A and the circular shaped ablation pattern 207A are shown as examples, it should be understood that these are examples only and that any pattern that may be produced with a programmable mask such as described with respect to OALV 107 of FIG. 1 may be ablated. While the structure shown in FIG. 2A is a flat surface it should be understood that the ablation pattern can also be executed on a three-dimensional structures, including those having holes, cavities, or channels, edges, curved or irregular surfaces, or protrusions or projections.

FIG. 2B illustrates a programmable mask, laser-based shaped beam system 200B that enables spatially controlling chemical or other processing of a work surface that can be positioned in an optional chamber or ambient controlled volume 210B. In one embodiment, controlling a reactive process can use a system such as described with respect to FIG. 1. In a first example a shaped process laser beam 202B (corresponding to imaging beam 116 of FIG. 1) is patterned using a programmable mask (corresponding to OALV 107 of FIG. 1). The process laser beam 202B may be patterned with a rectangular pattern 203B. As a result, a rectangular shaped area with controlled material properties 204B is created. In a second example the process laser beam 205B may be patterned with a circular pattern 206B. As a result, a circular shaped area with controlled material properties 207B is created. The pattern may be created in an insulation layer 208B—e.g. a metal oxide above a substrate 209B. In some embodiments, an area with controlled material properties may be created by heating the area to a level below that required for ablation in an ambient or controlled environment. For example, heating a copper metal layer in air can form a copper oxide insulating layer. Depending on the heating or atmosphere (e.g. different gases, vacuum, liquid) different oxidation levels can be achieved (e.g. CuO or CuO₂). By using various different atmospheres and laser parameters the properties of the material can be controlled to create insulators, conductors, or semi-conductors by introducing a dopant. In some embodiments, complex three-dimensional structures can be obtained having different material properties in different areas.

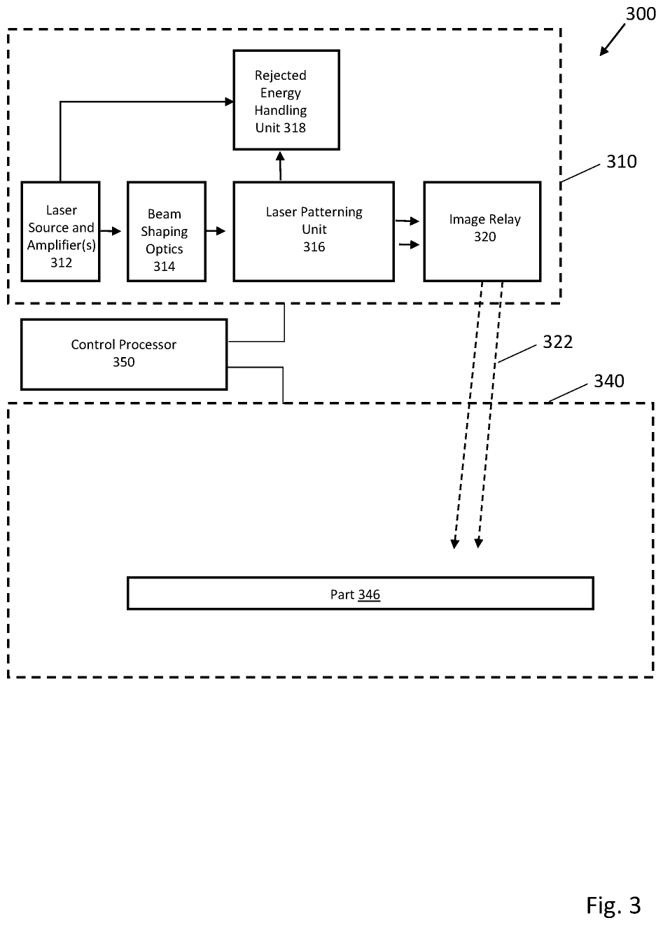

FIG. 3 illustrates an embodiment of a laser processing system 300. As seen in FIG. 3, a laser source and amplifier(s) 312 can be constructed as a continuous or pulsed laser. In other embodiments the laser source includes a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulsed source which uses a Pockels cell can be used to create an arbitrary length pulse train.

Possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl₂) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate(Nd:YVO4) laser, Neodymium doped yttrium calcium oxoborateNd:YCa₄O(BO₃)₃ or simply Nd:YCOB, Neodymium glass(Nd:Glass) laser, Titanium sapphire(Ti:sapphire) laser, Thulium YAG (Tm:YAG) laser, Ytterbium YAG (Yb:YAG) laser, Ytterbium:2O3 (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium)aluminum fluoride(Ce:LiSAF, Ce:LiCAF), Promethium 147 doped phosphate glass(147Pm+3:Glass) solid-state laser, Chromium doped chrysoberyl (alexandrite) laser, Erbium doped and erbium-ytterbium co-doped glass lasers, Trivalent uranium doped calcium fluoride (U:CaF2) solid-state laser, Divalent samarium doped calcium fluoride(Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

As illustrated in FIG. 3, the laser manufacturing system 300 suitable for supporting embodiments such as described with respect to FIG. 1 and FIGS. 1 and FIGS. 2A and 2B uses lasers able to provide one- or two-dimensional directed energy as part of an energy patterning system 310. In some embodiments, one dimensional patterning can be directed as linear or curved strips, as rastered lines, as spiral lines, or in any other suitable form. Two-dimensional patterning can include separated or overlapping tiles, or images with variations in laser intensity. Two-dimensional image patterns having non-square boundaries can be used, overlapping or interpenetrating images can be used, and images can be provided by two or more energy patterning systems. The energy patterning system 310 uses laser source and amplifier(s) 312 to direct one or more continuous or intermittent energy beam(s) toward beam shaping optics 314. After shaping, if necessary, the beam is patterned by an energy patterning unit 316, with generally some energy being directed to a rejected energy handling unit 318. Patterned energy is relayed by image relay 320 toward an article processing unit 340, in one embodiment as a two-dimensional image 322 focused at a part 346. Patterned energy, directed by the image relay 320, can melt, fuse, sinter, amalgamate, change crystal structure, influence stress patterns, or otherwise chemically or physically modify the part 346 to form structures with desired properties. A control processor 350 can be connected to variety of sensors, actuators, heating or cooling systems, monitors, and controllers to coordinate operation of the laser source and amplifier(s) 312, beam shaping optics 314, laser patterning unit 316, and image relay 320, as well as any other component of system 300. As will be appreciated, connections can be wired or wireless, continuous or intermittent, and include capability for feedback (for example, thermal heating can be adjusted in response to sensed temperature).

In some embodiments, beam shaping optics 314 can include a great variety of imaging optics to combine, focus, diverge, reflect, refract, homogenize, adjust intensity, adjust frequency, or otherwise shape and direct one or more laser beams received from the laser source and amplifier(s) 312 toward the laser patterning unit 316. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

The laser patterning unit 316 can include static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Rejected energy handling unit 318 is used to disperse, redirect, or utilize energy not patterned and passed through the image relay 320. In one embodiment, the rejected energy handling unit 318 can include passive or active cooling elements that remove heat from both the laser source and amplifier(s) 312 and the laser patterning unit 316. In other embodiments, the rejected energy handling unit can include a “beam dump” to absorb and convert to heat any beam energy not used in defining the laser pattern. In still other embodiments, rejected laser beam energy can be recycled using beam shaping optics 314. Alternatively, or in addition, rejected beam energy can be directed to the article processing unit 340 for heating or further patterning. In certain embodiments, rejected beam energy can be directed to additional energy patterning systems or article processing units.

In one embodiment, a “switchyard” style optical system can be used. Switchyard systems are suitable for reducing the light wasted in the laser manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based laser manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials.

Image relay 320 can receive a patterned image (either one or two-dimensional) from the laser patterning unit 316 directly or through a switchyard and guide it toward the article processing unit 340. In a manner similar to beam shaping optics 314, the image relay 320 can include optics to combine, focus, diverge, reflect, refract, adjust intensity, adjust frequency, or otherwise shape and direct the patterned light. Patterned light can be directed using movable mirrors, prisms, diffractive optical elements, or solid state optical systems that do not require substantial physical movement. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror the article processing unit 340 is substantially equivalent to the image distance. In effect, this enables a quick change in the optical beam delivery size and intensity across locations of a build area for different materials while ensuring high availability of the system.

In addition to material handling components, the article processing unit 340 can include components for holding and supporting 3D structures, mechanisms for heating or cooling the chamber, auxiliary or supporting optics, and sensors and control mechanisms for monitoring or adjusting material or environmental conditions. The article processing unit 340 can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO₂, N₂, O₂, SF₆, CH₄, CO, N₂O, C₂H₂, C₂H₄, C₂H₆, C₃H₆, C₃H₈, i-C₄H₁₀, C₄H10, 1-C₄H₈, cic-2, C₄H₇, 1,3-C₄H₆, 1,2-C₄H₆, C₅H₁₂, n-C₅H₁₂, i-C₅H12, n-C₆H₁₄, C₂H₃Cl, C₇H₁₆, C₈H₁₈, C₁₀H₂₂, C₁₁H₂₄, C₁₂H₂₆, C₁₃H₂₈, C₁₄H₃₀, C₁₅H₃₂, C₁₆H₃₄, C₆H₆, C₆H₅—CH₃, C₈H₁₀, C₂H₅OH, CH₃OH, or iC₄H₈. In some embodiments, refrigerants or large inert molecules (including but not limited to sulfur hexafluoride) can be used. In some embodiments, a pure or diluted atomic or molecular precursors atmosphere can be included to be incorporated in the material processed by a beam. An enclosure atmospheric composition to have at least about 1% He by volume (or number density), along with selected percentages of inert/non-reactive gasses can be used.

Control processor 350 can be connected to control any components of laser manufacturing system 300 described herein, including lasers, laser amplifiers, optics, heat control, build chambers, and manipulator devices. The control processor 350 can be connected to variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 350 is provided with an interface to allow input of manufacturing instructions. Use of a wide range of sensors allows various feedback control mechanisms that improve quality, manufacturing throughput, and energy efficiency.

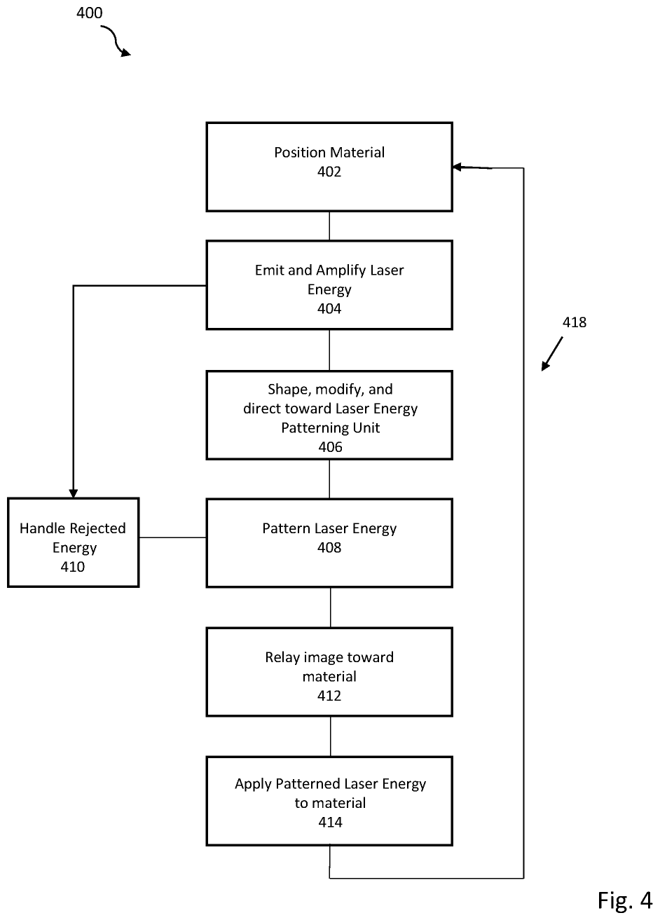

One embodiment of operation of a manufacturing system suitable for materials processing or subtractive manufacture is illustrated in FIG. 4. In this embodiment, a flow chart 400 illustrates one embodiment of a manufacturing process supported by the described optical and mechanical components. In step 402, a tool, workpiece, or material needing processing is positioned in a cartridge, bed, chamber, or other suitable support. In some embodiments a manipulator device such as a crane, lifting gantry, robot arm, or similar that allows for the manipulation of parts that can be difficult or impossible for a human to move can be used. The manipulator device can grasp various permanent or temporary manipulation points on a part to enable repositioning or maneuvering of the part. In some embodiments, the material can be a metal part or other material that can benefit from laser peening, ablation, or cutting using subtractive manufacture techniques. Laser processing can be used to induce to changes in crystal structure, influence stress patterns, or otherwise chemically or physically modified to form structures with desired properties.

In step 404, unpatterned laser energy is emitted by one or more energy emitters, including but not limited to solid state or semiconductor lasers, and then amplified by one or more laser amplifiers. In step 406, the unpatterned laser energy is shaped and modified (e.g. intensity modulated or focused). In step 408, this unpatterned laser energy is patterned, with energy not forming a part of the pattern being handled in step 410 (this can include conversion to waste heat, recycling as patterned or unpatterned energy, or waste heat generated by cooling the laser amplifiers in step 404). In step 412, the patterned energy, now forming a one or two-dimensional image is relayed toward the material. In step 414, the image is applied to the material. These steps can be repeated (loop 418) until the image (or different and subsequent image) has been applied to all necessary regions of the material.

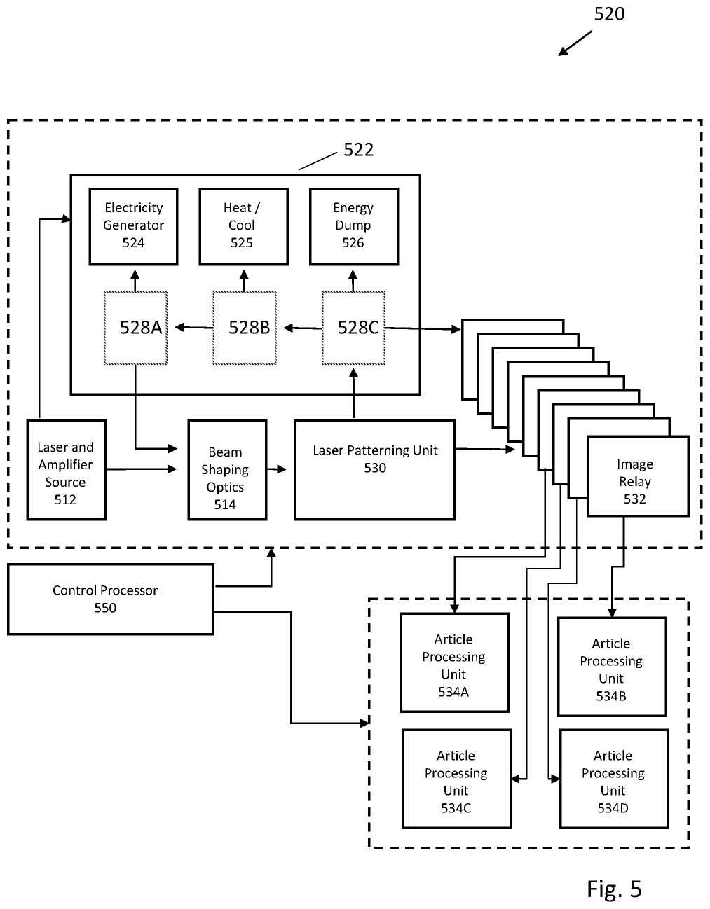

FIG. 5 is one embodiment of a laser manufacturing system that includes a phase change light valve and a switchyard system enabling reuse of patterned two-dimensional energy. A laser manufacturing system 520 has an energy patterning system with a laser and amplifier source 512 that directs one or more continuous or intermittent laser beam(s) toward beam shaping optics 514. Excess heat can be transferred into a rejected energy handling unit 522 that can include an active light valve cooling system. After shaping, the beam is two-dimensionally patterned by an energy patterning unit 530, with generally some energy being directed to the rejected energy handling unit 522. Patterned energy is relayed by one of multiple image relays 532 toward one or more article processing units 534A, 534B, 534C, or 534D, typically as a two-dimensional image focused on a part, structure, or material. Patterned laser beams, directed by the image relays 532, can melt, fuse, sinter, amalgamate, change crystal structure, influence stress patterns, or otherwise chemically or physically modify the material to form structures with desired properties. Similar to the embodiment of FIG. 3, a control processor 550 can be connected to variety of sensors, actuators, heating or cooling systems, monitors, and controllers to coordinate operation of various components of laser manufacturing system 520.

In this embodiment, the rejected energy handling unit has multiple components to permit reuse of rejected patterned energy. Coolant fluid from the laser amplifier and source 512 can be directed into one or more of an electricity generator 524, a heat/cool thermal management system 525, or an energy dump 526. Additionally, relays 528A, 528B, and 528C can respectively transfer energy to the electricity generator 524, the heat/cool thermal management system 525, or the energy dump 526. Optionally, relay 528C can direct patterned energy into the image relay 532 for further processing. In other embodiments, patterned energy can be directed by relay 528C, to relay 528B and 528A for insertion into the laser beam(s) provided by laser and amplifier source 512. Reuse of patterned images is also possible using image relay 532. Images can be redirected, inverted, mirrored, sub-patterned, or otherwise transformed for distribution to one or more article processing units 534A-D. Advantageously, reuse of the patterned light can improve energy efficiency of the laser manufacturing process, and in some cases improve energy intensity directed at a bed or reduce manufacture time.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A laser manufacturing system, comprising
a laser patterning unit having an optically addressed light valve;
an image relay able to direct a patterned laser beam from the laser patterning unit against a part; wherein
the patterned laser beam can ablatively remove material from the part.

2. The laser manufacturing system of claim 1, wherein the part has multiple material layers, with selected layers being removable.

3. The laser manufacturing system of claim 1, wherein the patterned laser beam can further induce selected chemical reactions in part material.

4. The laser manufacturing system of claim 1, wherein the patterned laser beam can further laser peen part material.

5. The laser manufacturing system of claim 1, wherein the laser patterning unit provides one-dimensional patterning.

6. The laser manufacturing system of claim 1, wherein the laser patterning unit provides two-dimensional patterning.

7. A laser manufacturing system, comprising
a laser patterning unit having an optically addressed light valve;
an image relay able to direct a patterned laser beam from the laser patterning unit against a part; wherein
the patterned laser beam can induce selected chemical reactions or transformation in part material.

8. The laser manufacturing system of claim 7, wherein the patterned laser beam can further ablatively remove material from the part.

9. The laser manufacturing system of claim 7, wherein the part has multiple material layers, with selected layers being removable.

10. The laser manufacturing system of claim 7, wherein the patterned laser beam can further laser peen part material.

11. The laser manufacturing system of claim 7, wherein the laser patterning unit provides one-dimensional patterning.

12. The laser manufacturing system of claim 7, wherein the laser patterning unit provides two-dimensional patterning.

13. A laser manufacturing method, comprising
providing a laser patterning unit having an optically addressed light valve;
directing a patterned laser beam from the laser patterning unit against a part using an image relay; and
with the patterned laser beam acting to at least one of 1) induce selected chemical reactions and 2) ablatively remove material from the part using the patterned laser beam.
